(19) United States
(12) Patent Application Publication
(10) Pub. No.: US 2016/0321667 A1
(43) Pub. Date: Nov. 3, 2016

(54) COMPUTERIZED SYSTEM AND METHOD FOR OFFLINE IDENTITY AUTHENTICATION OF A USER CROSS-REFERENCE TO RELATED APPLICATIONS

(71) Applicant: Alibaba Group Holding Limited, Grand Cayman (KY)

(72) Inventor: Jian Qin, Hangzhou (CN)

(21) Appl. No.: 15/085,192

(22) Filed: Mar. 30, 2016

(30) Foreign Application Priority Data
Apr. 30, 2015 (CN) 201510218172.0

(51) Int. Cl. G06Q 20/40; G06Q 20/32

(52) U.S. Cl. CPC G06Q 20/4014; G06Q 20/322

(57) ABSTRACT

Disclosed are systems and methods for improving interactions with and between computers in authenticating, identifying, searching, generating, hosting and/or content providing systems supported by or configured with personal computing devices, servers and/or platforms. The systems interact to identify and retrieve data within or across platforms, which can be used to improve the quality of data used in processing interactions between or among processors in such systems. The disclosed systems and methods enable offline identity authentication for a user when performing activities online that require, and/or are based on, confirmation of a user's identity. The disclosed systems and methods enable the confirmation of a user's identity and/or account information through an offline authentication process between two terminals associated with the user.

### CROSS-REFERENCE TO RELATED APPLICATIONS

This application claims the benefit of priority from Chinese Patent Application No. 201510218172.0, filed on Apr. 30, 2015, entitled “Method of Offline Identity Authentication, Intelligent Terminal and System Thereof,” which is incorporated herein in its entirety by reference.

### TECHNICAL FIELD

The present disclosure relates generally to improving the performance of content authenticating, searching, generating, providing, recommending and/or hosting computer systems and/or platforms by modifying the capabilities and providing non-native functionality to such systems and/or platforms for offline identity authentication of a user.

### BACKGROUND

In recent years, with the advanced developments in science and technology, more and more users conduct mobile payments by using applications of third-party payment platforms installed on portable smart mobile terminals, such as, for example, mobile phones, tablet computers and the like. During transactions occurring on or within third-party payment platforms, after choosing a desired commodity, a buyer completes payment for the commodity by using an account registered on the third-party payment platform, and the third-party payment platform notifies the seller that the payment has been made and instructs the seller to deliver the commodity. After the buyer examines the delivered commodity, the buyer notifies the third-party payment platform to transfer the payment to the seller, and upon receiving the notification, the third-party payment platform transfers the payment to the seller's account.

Within conventional systems, when a mobile payment is made by using an application of a third-party payment platform, the application of the third-party payment platform needs to be opened, and relevant information such as account, password and the like needs to be input on the mobile terminal. In addition, identity authentication needs to be performed where the mobile terminal is connected to the Internet. However, when a mobile terminal is offline, the identity authentication fails to proceed, resulting great inconvenience in mobile payment.

### SUMMARY

In view of the above, the present disclosure provides systems and methods for an offline identity authentication. The disclosed systems and methods enable, during a mobile payment process, the processing of identity authentication without an internet connection, without a need to open an application of a third-party payment platform on a mobile terminal, and without requiring a user to input relevant information such as account and password. Thus, the disclosed systems and methods improve convenience and usability in mobile payment processing.

According to some embodiments of the present disclosure, an offline identity authentication method is disclosed, comprising the steps of:

upon receiving a payment trigger message, sending, by a first smart terminal, broadcast information to a second smart terminal, wherein the broadcast information carries identifier information of the first smart terminal, and a payment account is bound to the first smart terminal in advance; upon receiving a status code returned from the second smart terminal, generating, by the first smart terminal, an identity authentication password according to system time and the bound payment account, wherein the status code is sent by the second smart terminal when it is determined that the identifier information of the first smart terminal has been registered in a payment system; and returning the identity authentication password back to the second smart terminal.

In some embodiments, the identifier information of the first smart terminal is a device name and/or model of the first smart terminal.

In some embodiments, the system time is payment system time acquired by the first smart terminal when being registered in the payment system in advance.

In some embodiments, the identity authentication password is returned to the second smart terminal via Bluetooth®.

In some embodiments, the first smart terminal is a smart bracelet or smart watch.

According to some embodiments of the present disclosure, an offline identity authentication method is disclosed, comprising the steps of:

receiving and parsing broadcast information sent by a first smart terminal, and acquiring identifier information of the first smart terminal, wherein the broadcast information carries the identifier information of the first smart terminal, and a payment account is bound to the first smart terminal in advance; sending a status code to the first smart terminal when it is determined that the identifier information of the first smart terminal has been registered in a payment system, such that the first smart terminal generates an identity authentication password according to system time and the payment account bound to the first smart terminal; and receiving the identity authentication password returned from the first smart terminal.

In some embodiments, when it is determined that the identifier information of the first smart terminal has been registered in the payment system, the second smart terminal establishes a Bluetooth® connection with the first smart terminal, and sends the status code to the first smart terminal.

In some embodiments, upon the receipt of the identity authentication password comprises the steps of: testing integrity of the identity authentication password; and upon a successful testing of the integrity of the identity authentication password, transferring the identity authentication password to a payment system application installed in the second smart terminal, such that the payment system application assembles transaction sheet information and sends the information to the payment system.

According to some embodiments of the present disclosure, a first smart terminal is disclosed, comprising:

a broadcast sending unit, configured to, upon receiving a payment trigger message, send broadcast information to a second smart terminal, wherein the broadcast information carries identifier information of the first smart terminal, and a payment account is bound to the first smart terminal in advance; a first receiving unit, configured to receive a status code returned from the second smart terminal; a password generating unit, configured to, after the first receiving unit receives the status code, generate an identity authentication password according to system time and the bound payment account, wherein the status code is sent by the second smart terminal when it is determined that the identifier information of the first smart terminal has been registered in a payment system; and a first sending unit, configured to return the identity authentication password to the second smart terminal.

In some embodiments, the identifier information of the first smart terminal is a device name and/or model of the first smart terminal; the system time is payment system time acquired by the first smart terminal when being registered in the payment system in advance; the first sending unit returns the identity authentication password to the second smart terminal via Bluetooth; and the first smart terminal is a smart bracelet or smart watch (e.g., a wearable device).

According to some embodiments of the present disclosure, a second smart terminal is disclosed, comprising:

a second receiving unit, configured to receive and parse broadcast information sent by a first smart terminal; a parsing unit, configured to parse the broadcast information sent by the first smart terminal, and to acquire identifier information of the first smart terminal, wherein the broadcast information carries the identifier information of the first smart terminal, and a payment account is bound to the first smart terminal in advance; a second sending unit, configured to send a status code to the first smart terminal when it is determined that the identifier information of the first smart terminal has been registered in a payment system, such that the first smart terminal generates an identity authentication password according to system time and the payment account bound to the first smart terminal; and a third receiving unit, configured to receive the identity authentication password returned from the first smart terminal.

In some embodiments, the second sending unit is further configured to, when it is determined that the identifier information of the first smart terminal has been registered in the payment system, establish a Bluetooth connection between the second smart terminal and the first smart terminal, and send the status code to the first smart terminal.

In some embodiments, the second smart terminal (i.e., device) further comprises:

a testing unit, configured to test integrity of the identity authentication password; and

a third sending unit, configured to, upon a successful testing of the integrity of the identity authentication password, transfer the identity authentication password to a payment system application installed in the second smart terminal, such that the payment system application assembles transaction sheet information and sends the information to the payment system.

According to some embodiments of the present disclosure, an offline identity authentication system is disclosed, which comprises the first smart terminal and the second smart terminal.

As evidenced from the disclosed technical solutions discussed herein, upon receiving a payment trigger message, a first smart terminal of a payment account sends broadcast information carrying identifier information of the first smart terminal to a second smart terminal; once the second smart terminal validates that the identifier information of the first smart terminal has been registered in a payment system, and thus instructing the first smart terminal to generate an identity authentication password and transfer the password to the second smart terminal; the second smart terminal validates the password received by the second smart terminal, such that the password is transferred to an application of the payment system. In this way, during a mobile payment process, identity authentication may proceed without an internet connection, without the need to open an application of a third-party payment platform on a mobile terminal, and without the need for a user to input relevant information such as account and password. In some embodiments, the disclosed identity authentication process can be performed as long as a payment trigger message is sent to the first smart terminal, thereby improving convenience in mobile payment.

In accordance with one or more embodiments, a non-transitory computer-readable storage medium is provided, the non-transitory computer-readable storage medium tangibly storing thereon, or having tangibly encoded thereon, computer readable instructions that when executed cause at least one processor to perform a method for offline identity authentication of a user, as discussed herein.

In accordance with one or more embodiments, a system is provided that comprises one or more computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### BRIEF DESCRIPTION OF THE DRAWINGS

The foregoing and other objects, features, and advantages of the disclosure will be apparent from the following description of embodiments as illustrated in the accompanying drawings, in which reference characters refer to the same parts throughout the various views.

The drawings are not necessarily to scale, emphasis instead being placed upon illustrating principles of the disclosure:

FIG. 1 is a schematic flowchart illustrating a non-limiting embodiment of an offline identity authentication process according to some embodiments of the present disclosure;

FIG. 2 is a schematic structural diagram illustrating a non-limiting embodiment of a first smart terminal according to some embodiments of the present disclosure;

FIG. 3 is a schematic structural diagram illustrating a non-limiting embodiment of a second smart terminal according to some embodiments of the present disclosure; and

FIG. 4 is a schematic structural diagram illustrating a non-limiting embodiment of the second smart terminal according to some embodiments of the present disclosure.

### DETAILED DESCRIPTION

The present disclosure will now be described more fully hereinafter with reference to the accompanying drawings, which form a part hereof, and which show, by way of illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

These computer program instructions can be provided to a processor of: a general purpose computer to alter its function to a special purpose; a special purpose computer; ASIC; or other programmable digital data processing apparatus, such that the instructions, which execute via the processor of the computer or other programmable data processing apparatus, implement the functions/acts specified in the block diagrams or operational block or blocks, thereby transforming their functionality in accordance with embodiments herein.

For the purposes of this disclosure a computer readable medium (or computer-readable storage medium/media) stores computer data, which data can include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a wired or wireless line or link, for example.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further include a system of terminals, gateways, routers, or the like coupled by wireless radio links, or the like, which may move freely, randomly or organize themselves arbitrarily, such that network topology may change, at times even rapidly.

A wireless network may further employ a plurality of network access technologies, including Wi-Fi, Long Term Evolution (LTE), WLAN, Wireless Router (WR) mesh, or 2nd, 3rd, or 4th generation (2G, 3G or 4G) cellular technology, or the like. Network access technologies may enable wide area coverage for devices, such as client devices with varying degrees of mobility, for example.

For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

For purposes of this disclosure, a client (or consumer or user) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device an Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations. For example, a simple smart phone, phablet or tablet may include a numeric keypad or a display of limited functionality, such as a monochrome liquid crystal display (LCD) for displaying text. In contrast, however, as another example, a web-enabled client device may include a high-resolution screen, one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

A client device may include or may execute a variety of operating systems, including a personal computer operating system, such as a Windows, iOS or Linux, or a mobile operating system, such as iOS, Android, or Windows Mobile, or the like.

A client device may include or may execute a variety of possible applications, such as a client software application enabling communication with other devices, such as communicating one or more messages, such as via email, for example Yahoo! ® Mail, short message service (SMS), or multimedia message service (MMS), for example Yahoo! Messenger®, including via a network, such as a social network, including, for example, Tumblr®, Facebook®, LinkedIn®, Twitter®, Flickr®, or Google+®, Instagram™, to provide only a few possible examples. A client device may also include or execute an application to communicate content, such as, for example, textual content, multimedia content, or the like. A client device may also include or execute an application to perform a variety of possible tasks, such as browsing, searching, playing, streaming or displaying various forms of content, including locally stored or uploaded images and/or video, or games (such as fantasy sports leagues). The foregoing is provided to illustrate that claimed subject matter is intended to include a wide range of possible features or capabilities.

The principles described herein may be embodied in many different forms. The present disclosure provides systems and methods for offline identity authentication. According to the disclosed systems and methods, when a mobile payment is to be processed, authentication of the identity of the user, the user's device and/or the user's account can be processed without an internet connection, and without the need to open an application of a third-party payment platform on a mobile terminal. Additionally, the disclosed systems and methods remove the need, as with conventional payment and authentication systems, for inputting relevant payment, identity and/or account information, such as, but not limited to, account and password information. In some embodiments, the identity authentication process discussed herein can proceed as long as a payment trigger message is sent to a first smart terminal (e.g., the terminal initiating the payment process), thereby improving convenience in mobile payment.

Various non-limiting embodiments of the present disclosure are described hereinafter in detail with references to the accompanying drawings.

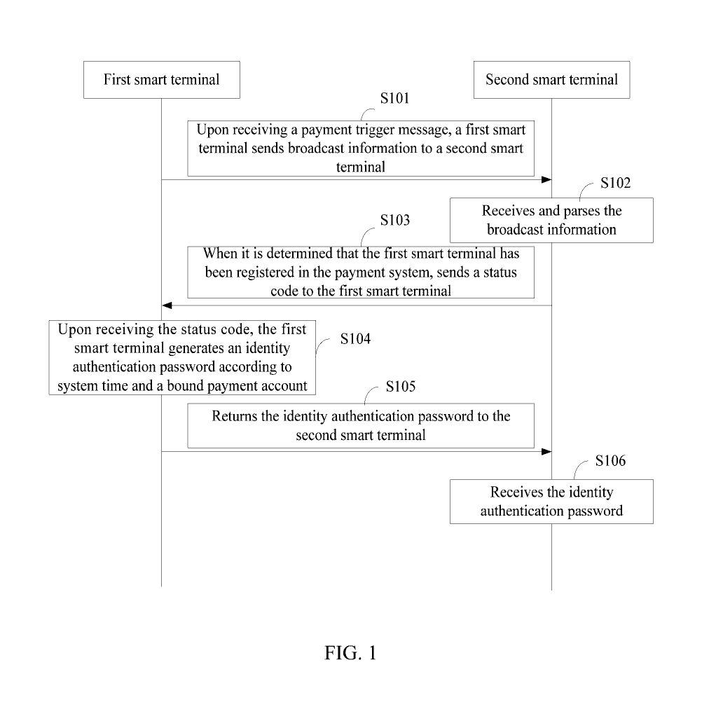

FIG. 1 is a schematic flowchart illustrating a non-limiting embodiment of an offline identity authentication method according to some embodiments of the present disclosure. As illustrated in FIG. 1, the process comprises the following steps:

In Step S101: Upon receiving a payment trigger message, a first smart terminal sends broadcast information to a second smart terminal.

In some embodiments, the first smart terminal and the second smart terminal register their identifier information in a payment system in advance respectively. In some embodiments, a payment account is bound to the first smart terminal in advance. For example, an Alipay® account may be written (e.g., stored) on or in association with the first smart terminal in advance.

In some embodiments, the first smart terminal can be a smart bracelet or smart watch, or may be any other type of known or to be known portable smart terminal; and the second smart terminal may be a smart terminal (which can be paired to the first device) connecting to a payment system, such as, for example, but not limited to, a smart vending machine.

When payment is desired, the button on the smart bracelet or smart watch may be pressed to trigger a payment trigger message.

The broadcast information sent by the first smart terminal to the second smart terminal at least comprises the identifier information of the first smart terminal, wherein the identifier information of the first smart terminal may be, but is not limited to, a device name and/or model of the first smart terminal, and the sent broadcast information may be a Bluetooth low energy (BLE) broadcast. When a payment trigger message is received, the number of broadcast times may be a predetermined, preset or pre-configured amount—for example, 20.

In Step S102: The broadcast information is received and parsed.

According to some embodiments, the second smart terminal receives the broadcast information, and upon receiving the broadcast information, the second smart terminal parses the broadcast information and acquires the identifier information of the first smart terminal carried in the broadcast information.

In Step S103: When it is determined that the first smart terminal has been registered in the payment system, a status code is sent to the first smart terminal.

In this step, according to some embodiments, after the second smart terminal parses the identifier information of the first smart terminal, the second smart terminal, according to a device registration information table acquired in advance from the payment system (wherein the device registration information table comprises the identifier information of the first smart terminal which has been registered in the payment system), traverses (i.e., searches) in the device registration information table the parsed identifier information of the first smart terminal. In some embodiments, if the corresponding registration information has been found in the device registration information table, it is determined that the first smart terminal has been registered in the payment system. In this case, a Bluetooth connection is established between the second smart terminal and the first smart terminal, and then the second smart terminal sends the status code to the first smart terminal via the Bluetooth connection.

In some embodiments, the device registration information table stored in the second smart terminal may be periodically updated from the payment system.

In Step S104: Upon receiving the status code, the first smart terminal generates an identity authentication password according to system time and a bound payment account.

Upon receiving the status code, the first smart terminal calls (or executes) an identity authentication password generation algorithm (e.g., HMAC-based One-time Password (HOTP)), and generates the identity authentication password according to the system time and the payment account bound to the first smart terminal.

In some embodiments, the system time may be the time when the first smart terminal registers in the payment system in advance, or may be the time when the first smart terminal periodically synchronizes the time with the payment system in a network connecting status.

In Step S105: The identity authentication password is returned to the second smart terminal.

In this step, the first smart terminal returns the generated identity authentication password to the second smart terminal. In some embodiments, the returning of the password may also be implemented via Bluetooth.

In Step S106: The identity authentication password is received.

The second smart terminal receives the identity authentication password sent by the first smart terminal.

According to some embodiments, upon receiving a payment trigger message, a first smart terminal of a payment account sends broadcast information carrying identifier information of the first smart terminal to a second smart terminal; once the second smart terminal validates that the identifier information of the first smart terminal has been registered in a payment system, and thus instructing the first smart terminal to generate an identity authentication password and transfer the password to the second smart terminal, the second smart terminal validates the password received by the second smart terminal, such that the password is transferred to an application of the payment system. In this way, in or during a mobile payment process or system, identity authentication may be processed without an internet connection, and without a need to open an application of a third-party payment platform on a mobile terminal. Additionally, identity authentication can be performed without receiving any input of relevant information such as, but not limited to, account and password. In some embodiments, the identity authentication process discussed herein can be performed as long as a payment trigger message is sent to the first smart terminal, which improves the convenience in mobile payment for a user, device and/or system, or some combination thereof.

According to some embodiments, after the second smart terminal receives the identity authentication password, the second smart terminal can perform a process comprising the steps of: testing, by the second smart terminal, the integrity of the identity authentication password; and upon a successful testing of the integrity of the identity authentication password, breaking, by the second smart terminal, the connection with the first smart terminal; and transferring, by the second smart terminal, the identity authentication password to a payment system application installed in the second smart terminal, such that the payment system application assembles transaction sheet information and sends the information to the payment system.

As discussed below, the disclosed technical solutions of the present disclosure are described with reference to a specific non-limiting example.

In the following example technical solution of the disclosed systems and methods, a description is given by using the scenario of identity identification between a smart bracelet and a smart vending machine as an example. However, it should be understood that the technical solution is not limited to such a scenario, as other similar scenarios, whether they are known or are to be known, can implement the disclosed steps without departing from the scope of the instant disclosure.

In this example, the smart bracelet has been registered in a payment system in advance, and a payment account has been bound to the smart bracelet; the smart vending machine is connected to the payment system in real time, and acquires a device registration information table from the payment system; and an example process of the identity authentication is as follows:

1. When receiving a payment trigger message, the smart bracelet sends a Bluetooth broadcast message to the smart vending machine, wherein the broadcast message carries the device name of the smart bracelet (for example, bongII: 07 09 62 6f 6e 67 49 49).

2. The smart vending machine is in a “master” mode, and constantly scans the surrounding environment. When receiving the broadcast message sent by the smart bracelet, the smart vending machine parses the broadcast message, and acquires the device name of the smart bracelet. The smart vending machine searches the device registration information table according to the device name of the smart bracelet, and if the corresponding data is found in the device registration information table, the smart vending machine then establishes a Bluetooth connection with the smart bracelet and sends a status code to the smart bracelet.

3. Upon receiving the status code, the smart bracelet calls an identity authentication password generation algorithm, such as, but not limited to, HOTP (a one-time password generation algorithm based on HMAC), wherein HMAC (Hash-based message authentication code) generates an 18-digit identity identification password according to the system time and the payment account bound to the smart bracelet; and finally the smart bracelet sends the identity authentication password to the smart vending machine via Bluetooth.

It should be understood that while the discussion herein references specific algorithms for performing password generation, it should not be construed as limiting, as any known or to be known password generation (or character string generation) algorithm, technique, software or mechanism can be utilized without departing from the scope of the instant disclosure.

4. Upon receiving the 18-digit identity authentication password, the smart vending machine verifies integrity of the identity authentication password; and after the verification is successful, the identity authentication code is sent to the main board of the smart vending machine via a serial port. In some embodiments, the main board runs the Android® system, and monitors the serial port at all times (it should be understood that while the discussion herein references the

Android platform, it should not be construed as limiting, as any type of device or operating system (OS) device or server platform is applicable to the disclosed systems and methods). Upon receiving the identity authentication password, the smart vending machine passes the 18-digit identity authentication password to an application of the smart vending machine.

5. The application of the smart vending machine receives the identity authentication password, assembles a transaction sheet, and submits the sheet to the payment system. After the payment is made in the payment system, the smart vending machine delivers the commodity.

It should be understood that the offline identity authentication process discussed herein is not only applicable to shopping, but also widely applicable to other scenarios where trusted identity authentication is desired; for example, the implementation (and/or execution) of the disclosed systems and methods can replace using a bank card, a bus card, a door access key, a shopping card and the like.

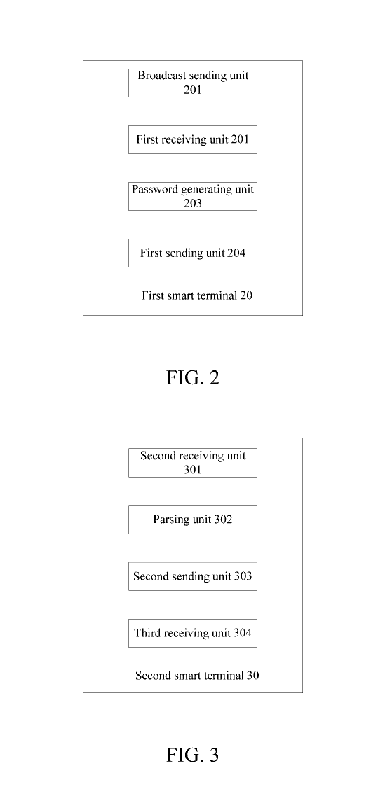

FIG. 2 is a schematic structural diagram illustrating a non-limiting embodiment of a first smart terminal according to some embodiments the present disclosure.

As illustrated in FIG. 2, the first smart terminal 20 comprises: a broadcast sending unit 201, configured to, upon receiving a payment trigger message, send broadcast information to a second smart terminal, wherein the broadcast information carries identifier information of the first smart terminal, and a payment account is bound to the first smart terminal 20 in advance, where the identifier information of the first smart terminal can be, for example, a device name and/or model of the first smart terminal;

a first receiving unit 202, configured to receive a status code returned from the second smart terminal;

a password generating unit 203, configured to, after the first receiving unit 202 receives the status code, generate an identity authentication password according to system time and the bound payment account, wherein the status code is sent by the second smart terminal when it is determined that the identifier information of the first smart terminal has been registered in a payment system; the system time is payment system time acquired by the first smart terminal when being registered in the payment system in advance; and

a first sending unit 204, configured to send the identity authentication password back to the second smart terminal.

The first sending unit sends the identity authentication password back to the second smart terminal via Bluetooth.

In some embodiments, the first smart terminal 20 is a smart bracelet or smart watch, as discussed above (e.g., a wearable smart device).

FIG. 3 is a schematic structural diagram illustrating a non-limiting embodiment of a second smart terminal 30 according to some embodiments of the present disclosure.

As illustrated in FIG. 3, the second smart terminal 30 comprises: a second receiving unit 301, configured to receive and parse broadcast information sent by the first smart terminal;

a parsing unit 302, configured to parse the broadcast information sent by the first smart terminal, and acquire identifier information of the first smart terminal, wherein the broadcast information carries the identifier information of the first smart terminal, and a payment account is bound to the first smart terminal in advance;

a second sending unit 303, configured to send a status code to the first smart terminal when it is determined that the identifier information of the first smart terminal has been registered in a payment system, such that the first smart terminal generates an identity authentication password according to system time and the payment account bound to the first smart terminal. In some embodiments, the second sending unit 303 is further configured to, when it is determined that the identifier information of the first smart terminal has been registered in the payment system, establish a Bluetooth connection between the second smart terminal and the first smart terminal, and send the status code to the first smart terminal;

a third receiving unit 304, configured to receive the identity authentication password returned from the first smart terminal.

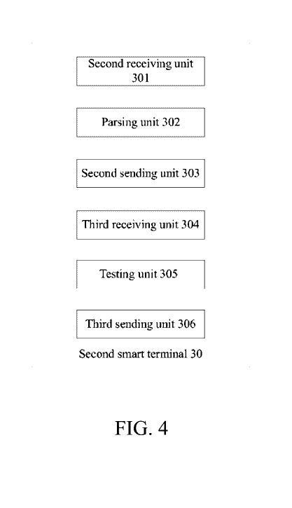

As illustrated in FIG. 4, the second smart terminal 30 can be further configured to comprise: a testing unit 305, configured to test integrity of the identity authentication password; and

a third sending unit 306, configured to, upon a successful testing of the integrity of the identity authentication password, pass (e.g., communicate) the identity authentication password to a payment system application installed in the second smart terminal, such that the payment system application assembles transaction sheet information and sends the information to the payment system.

As illustrated in FIGS. 2-4, in some embodiments, the present disclosure discloses an offline identity authentication system, which comprises a first smart terminal 20 and a second smart terminal 30. With reference to FIGS. 2-4, inter alfa, it should be understood that the terminal(s) and units discussed herein are non-exhaustive, as additional or fewer terminals and/or units may be applicable to the embodiments of the systems and methods discussed.

According to some embodiments of the present disclosure, in line with the discussion above respective to the discussion of FIGS. 1-4, upon receiving a payment trigger message, a first smart terminal of a payment account sends broadcast information carrying identifier information of the first smart terminal to a second smart terminal; once the second smart terminal validates that the identifier information of the first smart terminal has been registered in a payment system, and thus it instructs the first smart terminal to generate an identity authentication password and transfer the password to the second smart terminal;, the second smart terminal validates the password received by the second smart terminal, such that the password is passed to an application of the payment system. In this way, in and/or during a mobile payment process or system, identity authentication may proceed without an internet connection and without a need to open an application of a third-party payment platform on a mobile terminal. Additionally, the offline authentication process discussed herein removes the need for inputting relevant information, such as, for example, account and password. As discussed above, the identity authentication systems and methods discussed herein, in some embodiments, can be performed as long as a payment trigger message is sent to the first smart terminal, which improves the convenience and usability in executing mobile payment.

In addition, in some embodiments, the mobile terminal according to the present disclosure may be any known or to be known handheld terminal device having the Bluetooth function, such as a mobile phone and personal digital assistant (PDA) having the Bluetooth function, and the like.

In addition, the systems and methods, according to the present disclosure, may be implemented as a computer program executable by a processor (for example, CPU) of a mobile terminal, which may be stored in a memory of the mobile terminal. When the computer program is executed by the processor, the above functions defined in the methods and systems according to the disclosed embodiments of the present disclosure are implemented.

In addition, the systems and methods, according to the present disclosure, may also be implemented as a computer program product, wherein the computer program product comprises a computer readable medium. The computer program used for executing the above functions defined in the above discussed systems and methods according to embodiments of the present disclosure is stored in the computer readable medium.

Furthermore, the steps in the above disclosed systems and methods, and units in the above system, may also be implemented by using a controller and a computer readable storage device for storing the computer program in order for the controller to implement the above steps and functions of the units.

A person skilled in the art should understand that the disclosed combinations of various exemplary logical blocks, modules, circuits, and algorithm steps described in the present disclosure may be implemented as electronic hardware, computer software or a combination of both. In order to clearly describe such interchangeability of the hardware and software, functions of the various exemplary components, blocks, modules, circuits, and algorithm steps have been generally described thereof. Whether such functions are implemented as software or hardware depends on the specific application and the design restrictions applied to the entire system. A person skilled in the art may implement the above described functions in various manners in combination with the specific applications. However, such implementation decisions shall not be construed as causing a departure from the scope of the present disclosure.

While the foregoing disclosure illustrates exemplary embodiments of the present disclosure, it should be noted that without departing from the scope defined by the claims of the disclosed premise, various modifications and changes can be made. A method according to an embodiment of the disclosure described herein required functions, steps and/or actions need not be performed in any particular order. In addition, although elements of the present disclosure may be described or claimed in the individual form, but they can also be envisaged more unless explicitly restricted to the singular.

Although various embodiments of the present disclosure have been described with references to the drawings, a person skilled in the art will appreciate that the various embodiments of the present disclosure may also be subject to various improvements without departing from the disclosure of the present disclosure.

Professional personnel should be further aware that this combination of the various exemplary units and algorithm steps described in the embodiments of the present disclosure disclosed herein may be implemented in the form of electronic hardware, computer software or a combination thereof. In order to clearly describe interchangeability between the hardware and software, the above description has generally illustrates the compositions and steps of the various example according to the functions. Whether such functions are implemented in the form of software or hardware depend on the specific application of the technical solution and the design restrictions applied to the entire system. Professional technical personnel may implement the described functions by using different methods for each specific application. However, such implementation shall not be construed as going beyond the scope of the present disclosure.

A combination of the steps of the method or algorithms according to the embodiments of the present disclosure can be implemented by the hardware or a software module executed by a processor, or by a combination thereof. The software module may be stored in a random access memory (RAM), a memory, a read-only memory (ROM), an electrically programmable ROM, an electrically erasable programmable ROM, a register, a hard disk, a removable disk, a CD-ROM, or any other known or to be known form of storage medium known within the technical field.

For the purposes of this disclosure a module and unit is a software, hardware, or firmware (or combinations thereof) system, process or functionality, or component thereof, that performs or facilitates the processes, features, and/or functions described herein (with or without human interaction or augmentation). A module can include sub-modules; and a unit can comprise a sub-unit. Software components of a module/unit may be stored on a computer readable medium for execution by a processor. Modules/units may be integral to one or more servers or devices, or be loaded and executed by one or more servers/devices. One or more modules may be grouped into an engine or an application.

For the purposes of this disclosure the term “user”, “subscriber,” “buyer,” “consumer” or “customer” should be understood to refer to a user of an application or applications as described herein and/or a consumer of data supplied by a data provider. By way of example, and not limitation, the term “user” or “buyer” can refer to a person who receives data provided by the data or service provider over the Internet in a browser session, or can refer to an automated software application which receives the data and stores or processes the data.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

The above embodiments describe in detail the objectives, technical solutions, and beneficial effects of the present disclosure. It should be understood that these embodiments are for illustration purpose only, and not intended to limit the scope of protection of the present disclosure.

Any modification, equivalent replacement, and improvement made without departing from the spirit and principle of the present disclosure shall fall within the scope of protection of the present disclosure. Indeed, while various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising steps:
receiving, at a first computing device, a trigger message associated with an item, said trigger message comprising an instruction for sending information associated with a user to a third party associated with the item;
communicating, via the first computing device in response to receiving said trigger message, broadcast information associated with the first computing device to a second computing device, said broadcast information comprising identifying information of the first computing device;
receiving, at the first computing device from the second computing device, a status code providing an indication that said first computing device is a registered device;
generating, via the first computing device, an identity authentication password, said identity authentication password generated based, in part, upon a user account that is bound to the first computing device;
communicating, via the first computing device, said password to said second computing device for verification of the password; and
receiving, at the first computing device, information associated with said item based upon a determination by said second computing device that said password is verified.

2. The method of claim 1, wherein said communicated broadcast information is embodied as a Bluetooth Low Energy (BLE) broadcast.

3. The method of claim 1, further comprising:
establishing, via the first computing device, a Bluetooth connection with said second device, wherein said steps are performed via the Bluetooth connection.

4. The method of claim 1, wherein said user account is associated with said first computing device prior to receiving said trigger message, wherein said status code is based on said association.

5. The method of claim 1, wherein said generation of said identity authentication password comprises said first computing device using identity authentication generation software.

6. The method of claim 5, wherein said password comprises a Hash-based message authentication code (HMAC).

7. The method of claim 1, wherein said generation of said identity authentication password is further based on a system time.

8. The method of claim 7, wherein said system time comprises a time when said first computing device was registered, wherein said time is prior to receiving said trigger message.

9. The method of claim 7, wherein said system time comprises a time when said first computing device synchronized with said second computing device.

10. The method of claim 1, wherein said verification of the password is based on said second computing device assembling a transaction sheet and submitting the sheet to said third party.

11. The method of claim 1, wherein said status code is determined based upon a search of a device registration information table that comprises identifying information of registered devices.

12. The method of claim 1, wherein said first computing device is wearable device.

13. A non-transitory computer-readable storage medium tangibly encoded with computer-executable instructions, that when executed by a first computing device, perform a method comprising:
receiving, at a first computing device, a trigger message associated with an item, said trigger message comprising an instruction for sending information associated with a user to a third party associated with the item;
communicating, via the first computing device in response to receiving said trigger message, broadcast information associated with the first computing device to a second computing device, said broadcast information comprising identifying information of the first computing device;
receiving, at the first computing device from the second computing device, a status code providing an indication that said first computing device is a registered device;
generating, via the first computing device, an identity authentication password, said identity authentication password generated based, in part, upon a user account that is bound to the first computing device;
communicating, via the first computing device, said password to said second computing device for verification of the password; and
receiving, at the first computing device, information associated with said item based upon a determination by said second computing device that said password is verified.

14. The non-transitory computer-readable storage medium of claim 13, further comprising:
establishing, via the first computing device, a Bluetooth connection with said second device, wherein said steps are performed via the Bluetooth connection.

15. The non-transitory computer-readable storage medium of claim 13, wherein said generation of said identity authentication password comprises said first computing device using identity authentication generation software, wherein said password comprises a Hash-based message authentication code (HMAC).

16. The non-transitory computer-readable storage medium of claim 13, wherein said generation of said identity authentication password is further based on a system time.

17. The non-transitory computer-readable storage medium of claim 16, wherein said system time comprises a time when said first computing device was registered, wherein said time is prior to receiving said trigger message.

18. The non-transitory computer-readable storage medium of claim 16, wherein said system time comprises a time when said first computing device synchronized with said second computing device.

19. The non-transitory computer-readable storage medium of claim 13, wherein said verification of the password is based on said second computing device assembling a transaction sheet and submitting the sheet to said third party, and, wherein said status code is determined based upon a search of a device registration information table that comprises identifying information of registered devices.

20. A system comprising:
a processor;
a non-transitory computer-readable storage medium for tangibly storing thereon program logic for execution by the processor, the program logic comprising:
logic executed by the first computing device for receiving a trigger message associated with an item, said trigger message comprising an instruction for sending information associated with a user to a third party associated with the item;
logic executed by the first computing device for communicating, in response to receiving said trigger message, broadcast information associated with the first computing device to a second computing device, said broadcast information comprising identifying information of the first computing device;
logic executed by the first computing device for receiving, from the second computing device, a status code providing an indication that said first computing device is a registered device;
logic executed by the first computing device for generating an identity authentication password, said identity authentication password generated based, in part, upon a user account that is bound to the first computing device;
logic executed by the first computing device for communicating said password to said second computing device for verification of the password; and
logic executed by the first computing device for receiving information associated with said item based upon a determination by said second computing device that said password is verified.
